(19) United States
(12) Patent Application Publication
(10) Pub. No.: US 2016/0034548 A1
(43) Pub. Date: Feb. 4, 2016

(54) System and Method for Obtaining Automated Scaling of a Virtual Desktop Environment

(71) Applicant: Dell Products, LP, Round Rock, TX (US)

(72) Inventors: Farzad Khosrowpour, Pflugerville, TX (US); Victor Vahid Reza Mashayekhi, Round Rock, TX (US)

(21) Appl. No.: 14/448,564

(22) Filed: Jul. 31, 2014

(51) Int. Cl. G06F 17/30

(52) U.S. Cl. CPC G06F 17/30575

(57) ABSTRACT

A virtual desktop system includes a virtualization host, a backup virtualization host, and a virtual desktop manager. The virtual desktop manager routes traffic of the virtual desktop system to the virtualization host, provides a baseline replication of the virtualization host on the backup virtualization host, provides a first snapshot replication of the virtualization host on the backup virtualization host, determines that the virtualization host has experienced a trigger event, synchronizes the virtualization host with the backup virtualization host in response to determining that the virtualization host has experienced a trigger event, and re-routes traffic of the virtual desktop system to the backup virtualization host in response to synchronizing the virtualization host with the backup virtualization host.

### FIELD OF THE DISCLOSURE

This disclosure generally relates to information handling systems, and more particularly relates to automated scaling of a virtual desktop environment (VDI).

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems. A virtual desktop infrastructure separates a desktop environment and its associated software in a data center, from the information handling system that is used to access the desktop environment.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a virtual desktop environment according to an embodiment of the present disclosure;

FIGS. 2 and 3 illustrate a method for scaling the virtual desktop environment of FIG. 1;

FIG. 4 illustrates the method of FIGS. 2 and 3;

FIG. 5 illustrates a method of scaling the virtual desktop environment of FIG. 1; and

FIG. 6 is a block diagram illustrating a generalized information handling system according to an embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

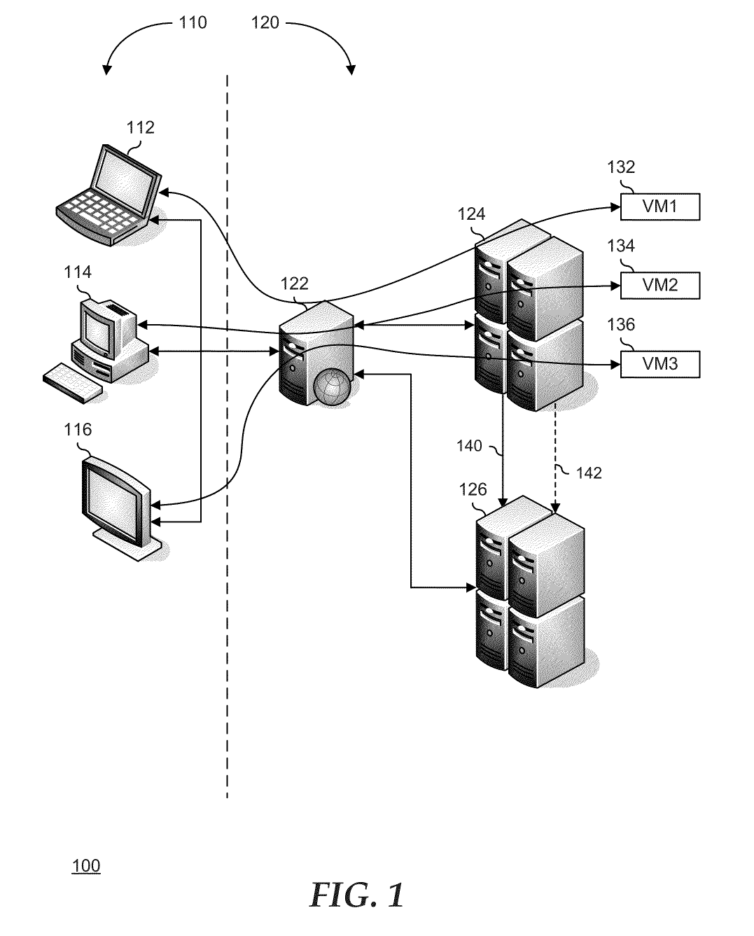

FIG. 1 illustrates a virtual desktop environment 100 that can be implemented on one or more information handling system. For purposes of this disclosure, an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a laptop computer, a smart phone, a tablet device or other consumer electronic device, a network server, a network storage device, a switch, a router, or another network communication device, or any other suitable device and may vary in size, shape, performance, functionality, and price. Further, an information handling system can include processing resources for executing machine-executable code, such as a central processing unit (CPU), a programmable logic array (PLA), an embedded device such as a System-on-a-Chip (SoC), or other control logic hardware. An information handling system can also include one or more computer-readable medium for storing machine-executable code, such as software or data. Additional components of an information handling system can include one or more storage devices that can store machine-executable code, one or more communications ports for communicating with external devices, and various input and output (I/O) devices, such as a keyboard, a mouse, and a video display. An example of an information handling system includes a multi-tenant chassis system where groups of tenants (users) share a common chassis, and each of the tenants has a unique set of resources assigned to them. The resources can include blade servers of the chassis, input/output (I/O) modules, Peripheral Component Interconnect-Express (PCIe) cards, storage controllers, and the like.

Virtual desktop environment 100 includes a user environment 110 and a virtual desktop infrastructure (VDI) 120. User environment 110 includes user systems 112, 114, and 116. VDI 120 includes a virtual desktop manager 122, a virtualization host 124, and a backup virtualization host 126. Virtual desktop environment 100 operates to present a remotely operated and maintained operating system environment and application software to users 112, 114, and 116. In particular, when one of users 112, 114, and 116 logs on to VDI 120, virtual desktop manager 122 authenticates the user, determines the operating system environment and application software needs of the user, and directs virtualization host 124 to instantiate a virtual machine that is associated with the user, and that runs the operating system environment and application software. Virtualization host 124 includes a virtual machine manager (VMM) that operates to manage the virtual machines. Thus when user 112 logs on to VDI 120, virtual desktop manager 122 directs virtualization host 124 to instantiate a virtual machine 132 associated with the user. Similarly, a virtual machine 134 is instantiated when user 114 logs on to VDI 120, and a virtual machine 136 is instantiated when user 116 logs on.

In a particular embodiment, two or more of virtual machines 132, 134, and 136 are instantiated from a common image, such that each of the virtual machines is utilizing the same operating system environment and application software. In this way, any patches, modifications, or upgrades that are applied to the common image are thereby promulgated to the particular users 112, 114, or 116 that are using the common image. In this way, the cost of maintenance and service for virtual desktop environment 100 is reduced over maintaining separate operating system environments and application software for each of users' 112, 114, and 116 systems. By using the common image, each of users 112, 114, and 116 can operate using the same operating system environment and application software, without regard to what type of system each user operates. In another embodiment, one or more of virtual machines 132, 134, and 136 is instantiated from a different image, such that the virtual machine is utilizing a different operating system environment or application software.

In a particular embodiment, each of users 112, 114, and 116 log on to VDI 120 over a protected network, such as a corporate wide-area network (WAN), local area network (LAN), intranet, or the like, such that the users have secure access to their respective virtual machines 132, 134, and 136. In another embodiment, each of users 112, 114, and 116 log on to VDI 120 over a public network, such as the Internet, a publicly accessible Wi-Fi network, or the like. Here, desktop manager 122 operates to ensure that users 112, 114, and 116 have secure access to their respective virtual machines 132, 134, and 136. For example, desktop manager 122 can operate to provide a virtual private network (VPN) or another secure communication channel to users 112, 114, and 116. In this way, the access to each user to their respective operating system environments and application software is available to the users from remote locations and through a wide array of connected devices. In yet another embodiment, each of users 112, 114, and 116 have the option of using a protected network or a public network.

In a particular embodiment, virtual machines 132, 134, and 136 remain instantiated on virtualization host 124 when the respective users 112, 114, and 116 log off of their virtual desktop. Here, a particular user can be provided with unique access to their own virtual desktop, such that any changes made, such as to personalize the virtual desktop, are maintained after logging off and later logging back on in a later session. However, in this embodiment, virtualization host 124 incurs an overhead by keeping virtual machines 132, 134, and 136 instantiated, even when no user 112, 114, or 116 is logged on. In another embodiment, virtual machines 132, 134, and 136 remain instantiated on virtualization host 124 when the respective users 112, 114, and 116 log off of their virtual desktop. However, here no particular user is associated with a particular virtual desktop, and each time the user logs back on, the virtual desktop is unchanged from the previous session. In this embodiment, virtualization host 124 can keep one or more of virtual machines 132, 134, and 136 instantiated, and then can instantiate additional virtual machines as the number of users increases. For example, in this way a data center can allocate processing resources of virtualization host 124 to running virtual desktops during business hours, and can allocate the processing resources to other tasks during the off hours.

Virtual desktop manager 122 operates to manage the connections between users 112, 114, and 116 and VDI 120, including authentication, user locations, session state, timeouts, and the like. In the embodiment where virtual machines 132, 134, and 136 remain instantiated, virtual desktop manager 122 operates to manage the unused virtual machines, and assign a virtual machine to a user when a new user logs on to VDI 120. In the embodiment where virtual machines 132, 134, and 136 are dynamically instantiated on virtualization host 124, desktop manager 122 operates to determine when to instantiate new virtual machines, or to halt existing virtual machines.

VDI 120 operates to maintain a recoverable backup of the state of virtualization host 124 on backup virtualization host 126, such that failures within the virtualization host result in limited loss of data or processing state, and provides a seamless fail-over from processing on the virtualization host to processing on the backup virtualization host, with little to no visible effect, as seen by users 112, 114, and 116. As such, virtual desktop manager 122 employs various monitoring, detection, and alert systems to determine when a failover is needed, and to ensure the seamless failover from processing on virtualization host 124 to processing on backup virtualization host 126. Various events can be defined and monitored by virtual desktop manager 122 to trigger the failover, such as the addition of one or more users similar to users 112, 114, and 116, such that the number of instantiated virtual machines exceeds a threshold number of instantiated virtual machines, or exceeding one or more usage thresholds for the resources of virtualization host 124, such as CPU or storage usage thresholds, I/O bandwidth thresholds, network bandwidth thresholds, or other resource usage thresholds, an age threshold for the age of equipment in the virtualization host, failure of one or more components of the virtualization host, other trigger events, or a combination thereof. In a particular embodiment, backup virtualization host 126 represents an on-site backup system for VDI 120 that is collocated with virtualization host 124. In another embodiment, backup virtualization host 126 represents a remote backup system for VDI 120 that is located at a different location from virtualization host 124, such as in a cloud system.

In maintaining a recoverable backup of the state of virtualization host 124 on backup virtualization host 126, VDI 120 also operates to provide asynchronous replication of the virtualization host on the backup virtualization host. The replication can include replicating of images of virtual machines 132, 134, and 136, replicating data associated with the virtual machine images or with users 112, 114, and 116, system images, status information, and system state information for VDI 120, or other information related to the operation and control of the VDI, as needed or desired. In providing the asynchronous replication, VDI 120 operates to perform a baseline system replication 140 of virtualization host 124 onto backup virtualization host 126 and to perform one or more snapshot replications 142 on a periodic basis to capture changes to the system state for the interval of time between the baseline replication and the snapshot replication.

Baseline replication 140 represents a data and I/O intensive operation to capture the state of virtualization host 124 at a particular point in time. As such, baseline replication 140 captures all images, data, system information, and the like in an atomic operation. Note that the data and I/O operations do not need to be contiguous, but can be performed during one or more time periods as needed or desired to capture the full state of virtualization host 124. For example, baseline replication 140 can be performed during one or more times when other data processing tasks are experiencing less activity, such as late at night, or on weekends, or the baseline replication can be scheduled during otherwise high activity times, but can be performed using only excess processing and I/O bandwidth, between the normal processing activities. Snapshot replication 142 represents a less data and I/O intensive operation, as it only is needed to capture the changes to the system state. As such, snapshot replication 142 can be performed on a routinely scheduled basis, such as daily, weekly, monthly, another routinely scheduled time, or a combination thereof.

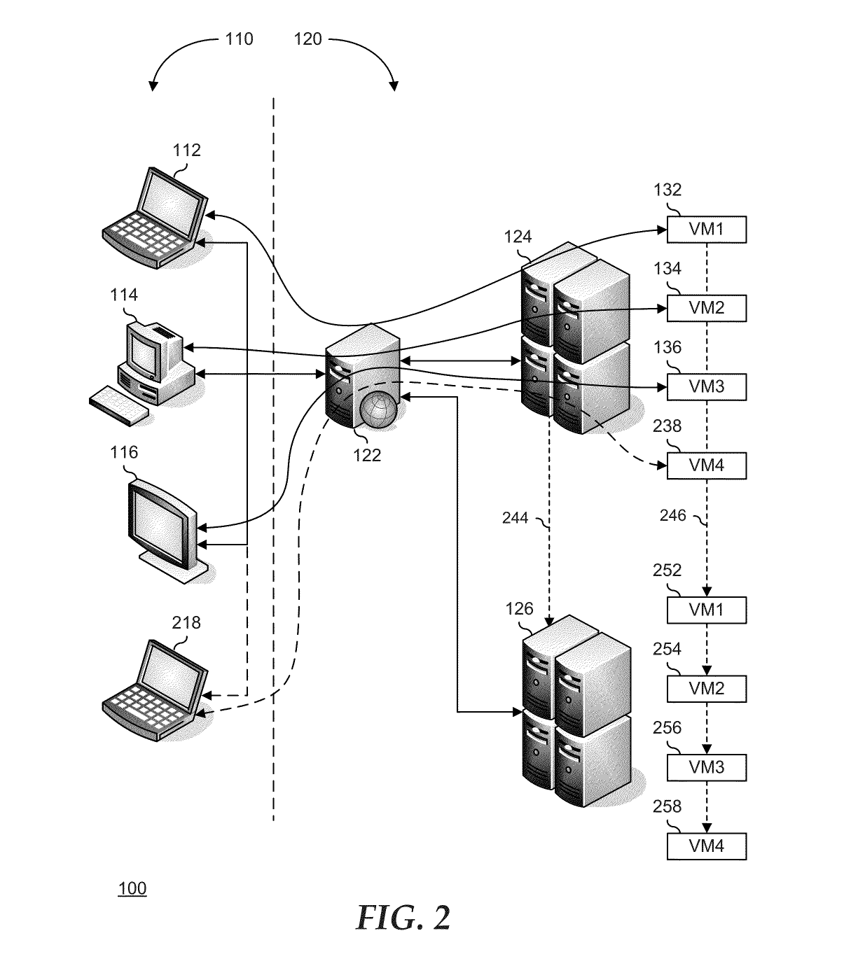

FIG. 2 illustrates virtual desktop environment 100, as described above, where the virtual desktop environment has experienced a trigger event. As illustrated, the trigger event is the addition of a new user 218. Here, when user 218 logs on to VDI 120, virtual desktop manager 122 authenticates the user, determines the operating system environment and application software needs of the user, and directs virtualization host 124 to instantiate a virtual machine 238 that is associated with the user, and that runs the operating system environment and application software. The addition of user 218 is a trigger event where VDI 120 is requested to service more users than the VDI is configured to accommodate. Note that this trigger event is provided for illustrative purposes, and that any of the trigger events, as described above, can cause VDI 120 to operate as described herein. When VDI 120 experiences the trigger event, the VDI switches from asynchronous replication to synchronization of virtualization host 124 with backup virtualization host 126. During the synchronization, a snapshot replication 244 is performed to bring virtualization host 124 and backup virtualization host 126 to a common data state, and virtual machines 252, 254, 256, and 258 are instantiated 246 on the backup virtualization host. Here, virtual machine 252 replicates the processing state of virtual machine 132, virtual machine 254 replicates the processing state of virtual machine 134, virtual machine 256 replicates the processing state of virtual machine 136, and virtual machine 258 replicates the processing state of virtual machine 238.

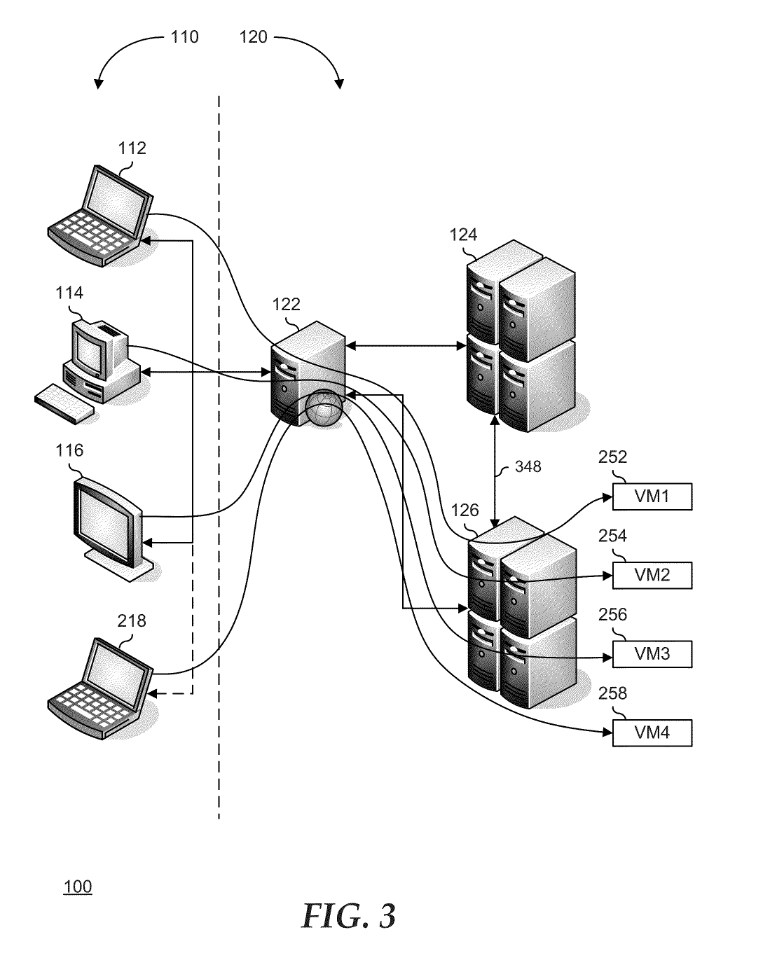

FIG. 3 illustrates virtual desktop environment 100, as described above, where backup virtualization host 126 has become synchronized with virtualization host 124, such that I/O operations that are directed to the virtualization host are similarly mapped to the backup virtualization host. Here, virtual desktop manager 122 operates to seamlessly map transactions from user 112 to virtual machine 252, from user 114 to virtual machine 254, from user 116 to virtual machine 256, and from user 118 to virtual machine 258. In this way, processing by virtualization host 124 can be transferred to backup virtualization host 126.

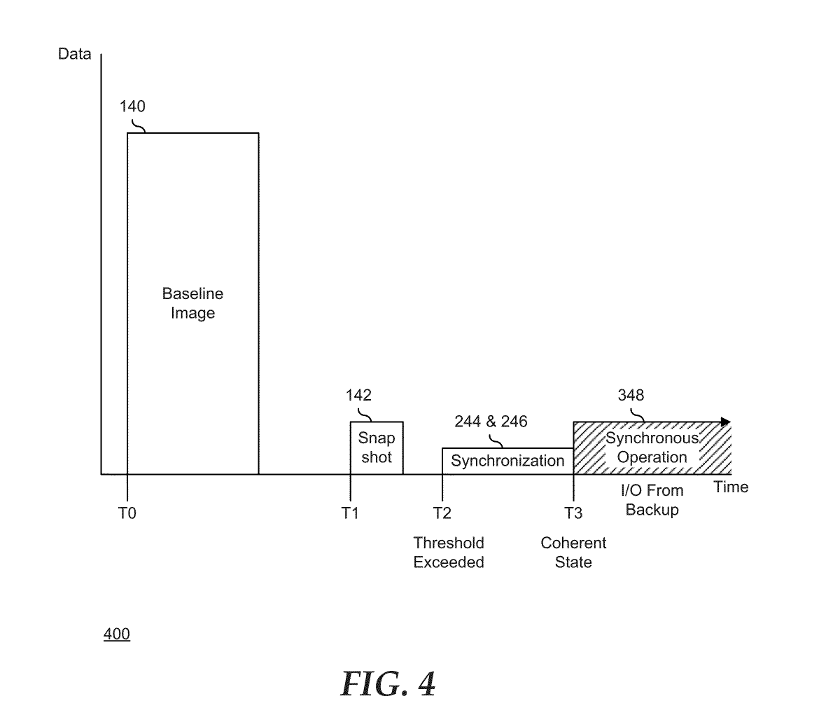

FIG. 4 illustrates the seamless transfer 400 of processing from virtualization host 124 to backup virtualization host 126, as described above. Here, at a time, T0, baseline replication 140 is illustrated as a data and I/O intensive operation to capture the state of virtualization host 124. Note that baseline transfer 140 represents the transfer of a large quantity of data that is performed over an extended duration of time. As such, performing baseline replication 140 is not necessarily a routine matter, but may be performed when virtual desktop environment 100 is set up, or has undergone a major reconfiguration. At a later time, T1, snapshot replication 144 is performed to capture the changes to virtual desktop environment 100. Note that snapshot replication 144 represents one or more actual snapshot replications which may occur prior to receiving a trigger event. At another time, T2, after snapshot replication 142, a trigger event occurs on virtual desktop environment 100 and VDI 120 switches from asynchronous replication to synchronization of virtualization host 124 with backup virtualization host 126, and a snapshot replication 244 is performed and virtual machines 252, 254, 256, and 258 are instantiated 246 on the backup virtualization host. Finally, at a later time T3, when backup virtualization host 126 has become synchronized with virtualization host 124, virtual desktop manager 122 operates to seamlessly remap transactions from the users to the new virtual machines.

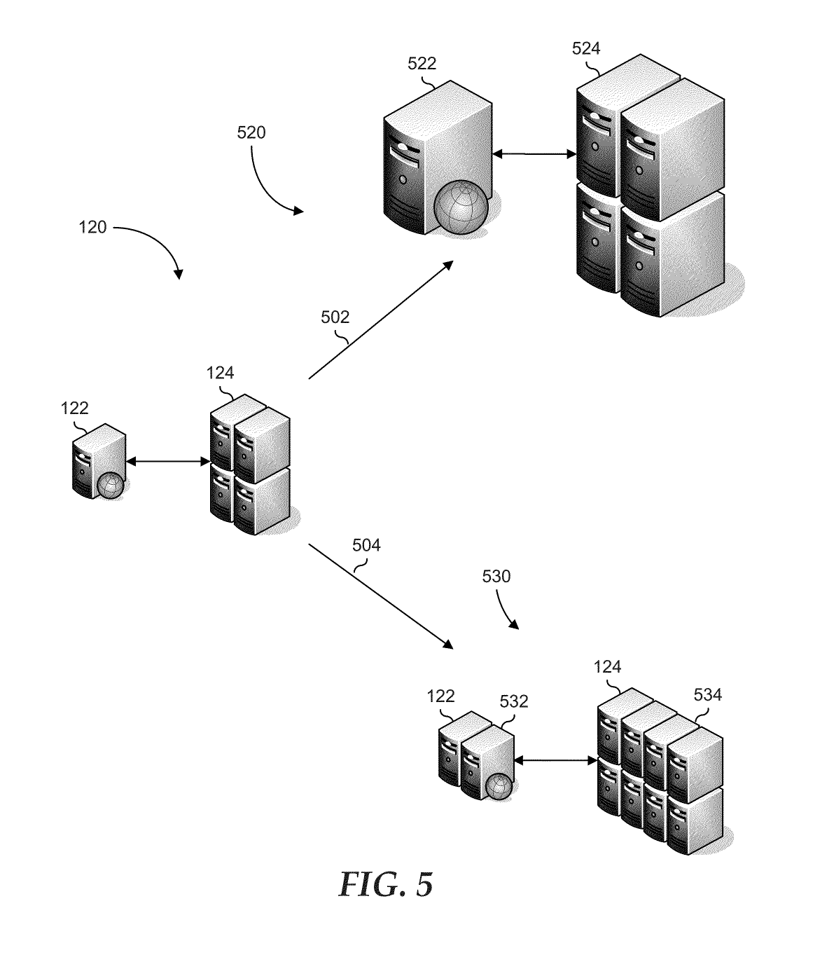

FIG. 5 illustrates methods for upgrading VDI 120 after having remapped transactions from the users to the new virtual machines. In a first method 502, the infrastructure of VDI 120 is completely replaced with a new VDI 520 that includes a larger virtual desktop manager 522 and a larger virtualization host 524. In a second method 504, the infrastructure of VDI 120 is expanded to create a new VDI 530 that adds a new virtual desktop manager 532 and a new virtualization host 534.

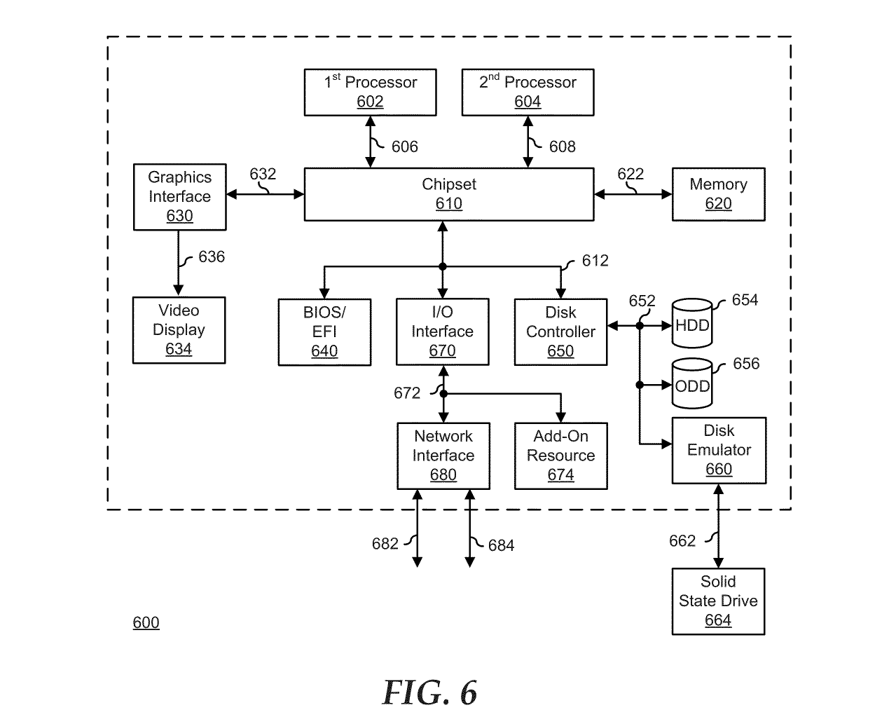

FIG. 6 illustrates a generalized embodiment of information handling system 600. For purpose of this disclosure information handling system 600 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 600 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 600 can include processing resources for executing machine-executable code, such as a central processing unit (CPU), a programmable logic array (PLA), an embedded device such as a System-on-a-Chip (SoC), or other control logic hardware. Information handling system 600 can also include one or more computer-readable medium for storing machine-executable code, such as software or data. Additional components of information handling system 600 can include one or more storage devices that can store machine-executable code, one or more communications ports for communicating with external devices, and various input and output (I/O) devices, such as a keyboard, a mouse, and a video display. Information handling system 600 can also include one or more buses operable to transmit information between the various hardware components.

Information handling system 600 can include devices or modules that embody one or more of the devices or modules described above, and operates to perform one or more of the methods described above. Information handling system 600 includes a processors 602 and 604, a chipset 610, a memory 620, a graphics interface 630, include a basic input and output system/extensible firmware interface (BIOS/EFI) module 640, a disk controller 650, a disk emulator 660, an input/output (I/O) interface 670, and a network interface 680. Processor 602 is connected to chipset 610 via processor interface 606, and processor 604 is connected to the chipset via processor interface 608. Memory 620 is connected to chipset 610 via a memory bus 622. Graphics interface 630 is connected to chipset 610 via a graphics interface 632, and provides a video display output 636 to a video display 634. In a particular embodiment, information handling system 600 includes separate memories that are dedicated to each of processors 602 and 604 via separate memory interfaces. An example of memory 620 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 640, disk controller 650, and I/O interface 670 are connected to chipset 610 via an I/O channel 612. An example of I/O channel 612 includes a Peripheral Component Interconnect (PCI) interface, a PCI-Extended (PCI-X) interface, a high-speed PCI-Express (PCIe) interface, another industry standard or proprietary communication interface, or a combination thereof. Chipset 610 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 640 includes BIOS/EFI code operable to detect resources within information handling system 600, to provide drivers for the resources, initialize the resources, and access the resources. BIOS/EFI module 640 includes code that operates to detect resources within information handling system 600, to provide drivers for the resources, to initialize the resources, and to access the resources.

Disk controller 650 includes a disk interface 652 that connects the disc controller to a hard disk drive (HDD) 654, to an optical disk drive (ODD) 656, and to disk emulator 660. An example of disk interface 652 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 660 permits a solid-state drive 664 to be connected to information handling system 600 via an external interface 662. An example of external interface 662 includes a USB interface, an IEEE 1394 (Firewire) interface, a proprietary interface, or a combination thereof. Alternatively, solid-state drive 664 can be disposed within information handling system 600.

I/O interface 670 includes a peripheral interface 672 that connects the I/O interface to an add-on resource 674 and to network interface 680. Peripheral interface 672 can be the same type of interface as I/O channel 612, or can be a different type of interface. As such, I/O interface 670 extends the capacity of I/O channel 612 when peripheral interface 672 and the I/O channel are of the same type, and the I/O interface translates information from a format suitable to the I/O channel to a format suitable to the peripheral channel 672 when they are of a different type. Add-on resource 674 can include a data storage system, an additional graphics interface, a network interface card (NIC), a sound/video processing card, another add-on resource, or a combination thereof. Add-on resource 674 can be on a main circuit board, on separate circuit board or add-in card disposed within information handling system 600, a device that is external to the information handling system, or a combination thereof.

Network interface 680 represents a NIC disposed within information handling system 600, on a main circuit board of the information handling system, integrated onto another component such as chipset 610, in another suitable location, or a combination thereof. Network interface device 680 includes network channels 682 and 684 that provide interfaces to devices that are external to information handling system 600. In a particular embodiment, network channels 682 and 684 are of a different type than peripheral channel 672 and network interface 680 translates information from a format suitable to the peripheral channel to a format suitable to external devices. An example of network channels 682 and 684 includes InfiniBand channels, Fibre Channel channels, Gigabit Ethernet channels, proprietary channel architectures, or a combination thereof. Network channels 682 and 684 can be connected to external network resources (not illustrated). The network resource can include another information handling system, a data storage system, another network, a grid management system, another suitable resource, or a combination thereof.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A virtual desktop system comprising:
a virtualization host;
a backup virtualization host; and
a virtual desktop manager operable to:
route traffic of the virtual desktop system to the virtualization host;
provide a baseline replication of the virtualization host on the backup virtualization host;
provide a first snapshot replication of the virtualization host on the backup virtualization host;
determine that the virtualization host has experienced a trigger event;
synchronize the virtualization host with the backup virtualization host in response to determining that the virtualization host has experienced a trigger event; and
re-route traffic of the virtual desktop system to the backup virtualization host in response to synchronizing the virtualization host with the backup virtualization host.

2. The virtual desktop system of claim 1, wherein the virtual desktop manager is further operable to:
de-synchronize the virtualization host from the backup virtualization host in response to re-routing traffic of the virtual desktop system to the backup virtualization host.

3. The virtual desktop system of claim 1, wherein, in providing the baseline replication, the virtual desktop manager is further operable to:
capture a state of the virtualization host at a particular point in time.

4. The virtual desktop system of claim 3, wherein the state of the virtualization host comprises at least one of virtual machine images, data, and system information.

5. The virtual desktop system of claim 3, wherein, in providing the first snapshot replication, the virtual desktop manager is further operable to:
capture the changes to the state of the virtualization host from the particular point in time to the point in time that the first snapshot replication is provided.

6. The virtual desktop system of claim 1, wherein the trigger event comprises at least one of an addition of a user to the virtual desktop system, the exceeding of a resource usage threshold of the virtualization host, the exceeding of an age threshold for the virtualization host, and failure of a component of the virtualization host.

7. The virtual desktop system of claim 1, wherein, in synchronizing the virtualization host with the backup virtualization host, the virtual desktop manager is further operable to:
provide a second snapshot replication of the virtualization host on the backup virtualization host; and
instantiate a virtual machine on the backup virtualization host.

8. A method comprising:
routing, by a virtual desktop manager, traffic of a virtual desktop system to a virtualization host;
providing a baseline replication of the virtualization host on a backup virtualization host;
providing a first snapshot replication of the virtualization host on the backup virtualization host;
determining that the virtualization host has experienced a trigger event;
synchronizing the virtualization host with the backup virtualization host in response to determining that the virtualization host has experienced a trigger event; and
re-routing, by the virtual desktop manager, traffic of the virtual desktop system to the backup virtualization host in response to synchronizing the virtualization host with the backup virtualization host.

9. The method of claim 8, further comprising:
de-synchronizing, by the virtual desktop manager, the virtualization host from the backup virtualization host in response to re-routing traffic of the virtual desktop system to the backup virtualization host.

10. The method of claim 8, wherein, in providing the baseline replication, the method further comprises:
capturing a state of the virtualization host at a particular point in time.

11. The method of claim 10, wherein the state of the virtualization host comprises at least one of virtual machine images, data, and system information.

12. The method of claim 10, wherein, in providing the first snapshot replication, the method further comprises:
capturing the changes to the state of the virtualization host from the particular point in time to the point in time that the first snapshot replication is provided.

13. The method of claim 8, wherein the trigger event comprises at least one of an addition of a user to the virtual desktop system, the exceeding of a resource usage threshold of the virtualization host, the exceeding of an age threshold for the virtualization host, and failure of a component of the virtualization host.

14. The method of claim 8, wherein, in synchronizing the virtualization host with the backup virtualization host, the method further comprises:
providing a second snapshot replication of the virtualization host on the backup virtualization host; and
instantiating a virtual machine on the backup virtualization host.

15. A non-transitory computer-readable medium including code for performing a method, the method comprising:
routing, by a virtual desktop manager, traffic of a virtual desktop system to a virtualization host;
providing a baseline replication of the virtualization host on a backup virtualization host;
providing a first snapshot replication of the virtualization host on the backup virtualization host;
determining that the virtualization host has experienced a trigger event;
synchronizing the virtualization host with the backup virtualization host in response to determining that the virtualization host has experienced a trigger event; and
re-routing, by the virtual desktop manager, traffic of the virtual desktop system to the backup virtualization host in response to synchronizing the virtualization host with the backup virtualization host.

16. The computer-readable medium of claim 15, the method further comprising:
de-synchronizing, by the virtual desktop manager, the virtualization host from the backup virtualization host in response to re-routing traffic of the virtual desktop system to the backup virtualization host.

17. The computer-readable medium of claim 15, wherein, in providing the baseline replication, the method further comprises:
capturing a state of the virtualization host at a particular point in time.

18. The computer-readable medium of claim 17, wherein, in providing the first snapshot replication, the method further comprises:
capturing the changes to the state of the virtualization host from the particular point in time to the point in time that the first snapshot replication is provided.

19. The computer-readable medium of claim 15, wherein the trigger event comprises at least one of an addition of a user to the virtual desktop system, the exceeding of a resource usage threshold of the virtualization host, the exceeding of an age threshold for the virtualization host, and failure of a component of the virtualization host.

20. The computer-readable medium of claim 15, wherein, in synchronizing the virtualization host with the backup virtualization host, the method further comprises:
providing a second snapshot replication of the virtualization host on the backup virtualization host; and
instantiating a virtual machine on the backup virtualization host.
